(19) United States
(12) Patent Application Publication
(10) Pub. No.: US 2026/0099898 A1
(43) Pub. Date: Apr. 9, 2026

(54) IMAGE ENHANCEMENT APPARATUS AND METHOD THEREOF

(71) Applicant: ASPEED Technology Inc., Hsinchu City (TW)

(72) Inventor: CHUNG-YEN LU, Hsinchu City (TW)

(21) Appl. No.: 18/907,926

(22) Filed: Oct. 7, 2024

(51) Int. Cl. G06T 5/20; G06T 5/73; G06T 5/92

(52) U.S. Cl. CPC G06T 5/20; G06T 5/73; G06T 5/92; G06T 2207/20024; G06T 2207/20192

(57) ABSTRACT

An image enhancement apparatus is disclosed, comprising: N line buffers, local window statistics (LWS) circuitry, tone mapping (TM) circuitry, edge enhancement (EE) circuitry and adaptive processing (AP) circuitry. The N line buffers receive N rows of a current image and outputs N² pixels according to a N×N local window. The LWS circuitry performs lowpass filtering operation over values of the N² pixels to generate a filtered value μ, and calculates a difference value Δ between μ and a value of a center pixel of the N² pixels. The TM circuitry produces a mapped value Yₘₐₚ according to a luma component μ_{Y} of μ and coordinates of the center pixel. The EE circuitry performs edge-enhancement filtering over the luma components of the N² pixels to produce a luma difference δ_{EE}. The AP circuitry updates the luma component of the center pixel according to four outputs (μ_{Y}, Δ_{Y}, Yₘₐₚ, δ_{EE}).

### BACKGROUND OF THE INVENTION

### Field of the Invention

The invention relates to image processing, and more particularly, to image enhancement apparatus and method thereof capable of simultaneously performing noise reduction, edge enhancement, and local contrast enhancement.

### Description of the Related Art

Image enhancement is a process of improving the visual quality, clarity and contrast of an image, generally by smoothing the image in uniform regions while preserving edges, and by sharpening features to simplify image interpretation for human observers and machine recognition. A typical image enhancement pipeline includes three serial stages: noise reduction, edge enhancement, and local contrast enhancement. The three serial stages may be carried out in a different order. Depending on a size (N×N) of a desired window or filter used in each stage, N line buffers are used to buffer N lines of pixels of an image for a corresponding stage, in order to keep data around and reduce the overall required memory bandwidth, where the line buffers are usually implemented by static random access memory (SRAM). For example, if N=3, FIG. 1 is an example showing a 3×3 Gaussian filter 11 sliding across a current image 10 for noise reduction stage. To apply the 3×3 Gaussian filter 11, there is no need to store the entire current image. Instead, a current row and its previous two rows of the current image must be stored in three line buffers 111˜113 (not shown). After the 3×3 Gaussian filter 11 slides over the pixels of the three rows in three line buffers 111˜113 with a stride of one pixel, the output pixels are sent to another three line buffers 114˜116 (not shown) for a downstream stage, such as the edge enhancement stage. After a 3×3 Sobel filter (not shown) slides over pixels of three rows in the three line buffers 114˜116 with a stride of one pixel, the output pixels are sent to another three line buffers 117˜119 (not shown) for a downstream stage, such as local contrast enhancement stage. In this manner, at least 3×N line buffers are required to complete the whole image enhancement pipeline.

Accordingly, what is needed is an image enhancement scheme to further reduce hardware cost and improve the computation efficiency without degrading image quality. The invention addresses such a need.

### SUMMARY OF THE INVENTION

In view of the above-mentioned problems, an object of the invention is to provide an image enhancement apparatus to reduce hardware cost and improve the computation efficiency.

One embodiment of the invention provides an image enhancement apparatus. The image enhancement apparatus comprises N line buffers, local window statistics (LWS) circuitry, tone mapping (TM) circuitry, edge enhancement (EE) circuitry and adaptive processing (AP) circuitry. The N line buffers receives N rows of a current image and outputs N² pixels according to a N×N local window sliding across the current image. The LWS circuitry is configured to perform lowpass filtering operation over values of the N² pixels to generate a filtered value μ, and to calculate a difference value Δ between μ and a value of a center pixel of the N² pixels located at the center of the N×N local window. The TM circuitry is configured to produce a mapped value Yₘₐₚ according to a luma component μ_{Y} of μ and coordinates of the center pixel. The EE circuitry is configured to perform edge-enhancement filtering over the luma components of the N² pixels to produce a luma difference δ_{EE}. The AP circuitry is configured to update the luma component of the center pixel according to four outputs (μ_{Y}, Δ_{Y}, Yₘₐₚ, δ_{EE}) from the LWS, the TM and the EE circuitry that operate in parallel, where Δ_{Y} denotes a luma component of Δ.

Another embodiment of the invention provides an image enhancement method. The image enhancement method comprises the steps of storing N rows of a current image by N line buffers to output N² pixels according to a N×N local window sliding across the current image; at a local window statistics (LWS) module, performing lowpass filtering operation over values of the N² pixels to generate a filtered value μ and calculating a difference value Δ between μ and a value of a center pixel of the N² pixels located at the center of the N×N local window; at a tone mapping (TM) module, producing a mapped value Yₘₐₚ according to a luma component μ_{Y} of μ and coordinates of the center pixel; at an edge enhancement (EE) module, performing edge-enhancement filtering over the luma components of the N² pixels to produce a luma difference δ_{EE}; and, at an adaptive processing (AP) module, updating the luma component of the center pixel according to four outputs (μ_{Y}, Δ_{Y}, Yₘₐₚ, δ_{EE}) from the LWS, the TM and the EE modules that operate in parallel, where Δ_{Y} denotes a luma component of Δ.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an example showing a 3×3 Gaussian filter 11 sliding across a current image 10 for noise reduction stage.

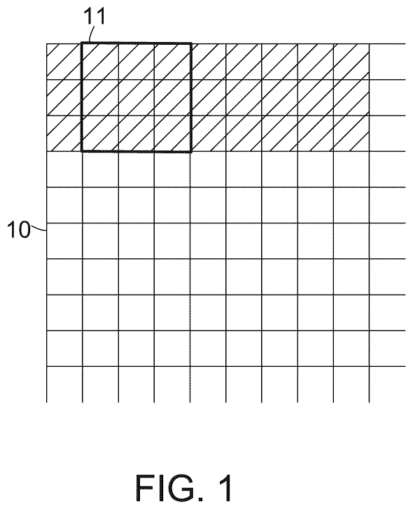

FIG. 2 is a block diagram of image enhancement apparatus 200 according to the invention.

FIG. 3 is a schematic diagram of LWS module 210 according to an embodiment of the invention.

FIG. 4 is a schematic diagram of TM module 220 according to an embodiment of the invention.

FIG. 5 is a schematic diagram of EE module 230 according to an embodiment of the invention.

### DETAILED DESCRIPTION OF THE INVENTION

As used herein and in the claims, the term “and/or” includes any and all combinations of one or more of the associated listed items. The use of the terms “a” and “an” and “the” and similar referents in the context of describing the invention are to be construed to cover both the singular and the plural, unless otherwise indicated herein or clearly contradicted by context. Further, the terms “circuitry” may refer to, is part of, or includes hardware components such as an electronic circuit, a logic circuit, a processor (shared, dedicated, or group) and/or memory (shared, dedicated, or group), an Application Specific Integrated Circuit (ASIC), a field-programmable gate array (FPGA), a programmable logic device (PLD), a programmable System on Chip (SoC), digital signal processors (DSPs), etc., that are configured to provide the described functionality. The term “module” includes a unit configured in hardware (circuitry), software, firmware or combination thereof, that is capable of performing the described functionality. Throughout the specification, the same components with the same function are designated with the same reference numerals.

A feature of the invention is to apply only N line buffers and a single local window with a size of (N×N) to eliminate tedious processing for the three serial stages (noise reduction, edge enhancement, and local contrast enhancement) of the image enhancement pipeline into one-stage processing (or one-window processing) to improve the computation efficiency and to save the computing power and hardware cost. Another feature of the invention is to process a current image by a local window statistics module, an edge enhancement module and a tone mapping module that operate in parallel to calculate preliminary parameters and then render an enhanced image according to the preliminary parameters on a pixel-by-pixel basis.

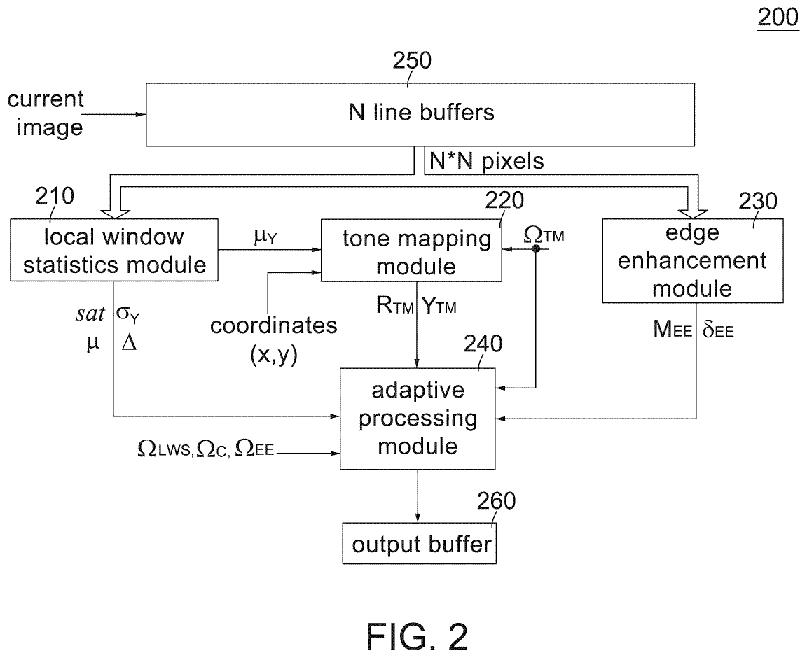

FIG. 2 is a block diagram of image enhancement apparatus 200 according to the invention. Referring to FIG. 2, the image enhancement apparatus 200 of the invention includes N line buffers 250, a local window statistics (LWS) module 210, a tone mapping (TM) module 220, an edge enhancement (EE) module 230, an adaptive processing (AP) module 240 and an output buffer 260, where N>2 and each of the N line buffers 250 stores pixels in one row of a current image. The N line buffers 250 are implemented with SRAM. The image enhancement apparatus 200 is configured to receive a current image by the N line buffers 250 and simultaneously perform noise reduction, edge enhancement (or sharpness) and local contrast enhancement operations over the current image by sliding a N×N single local window over the pixels of N rows in the N line buffers with a stride of one pixel to generate and store an enhanced image on a pixel-by-pixel basis in the output buffer 260. Here, N corresponds to a size of the single local window, such as a lowpass filter 310 in the LWS module 210 and a Sobel/Laplacian filter (512/511) in EE module 230. The LWS module 210, the TM module 220 and the EE module 230 operate in parallel. The current image is represented by three components: Y (luma), U (chroma), and V (chroma). For purposes of clarity and ease of description, hereinafter, the following examples and embodiments will be described with the assumption that N=3 and a 3×3 single local window is going to slide across the current image from left to right and from top to bottom.

The line buffers 250 receives three rows of the current image and then delivers a group of nine pixels at a time to the LWS module 210 and the EE module 230 based on the group of the nine pixels within the sliding 3×3 single local window. The coordinates of the group of nine pixels from left to right and from top are as follows: (x−1, y−1), (x, y−1), (x+1, y−1), (x−1, y), (x, y), (x+1, y), (x−1, y+1), (x, y+1) and (x+1, y+1), where a center pixel S(x, y) is located at the center of the 3×3 single local window.

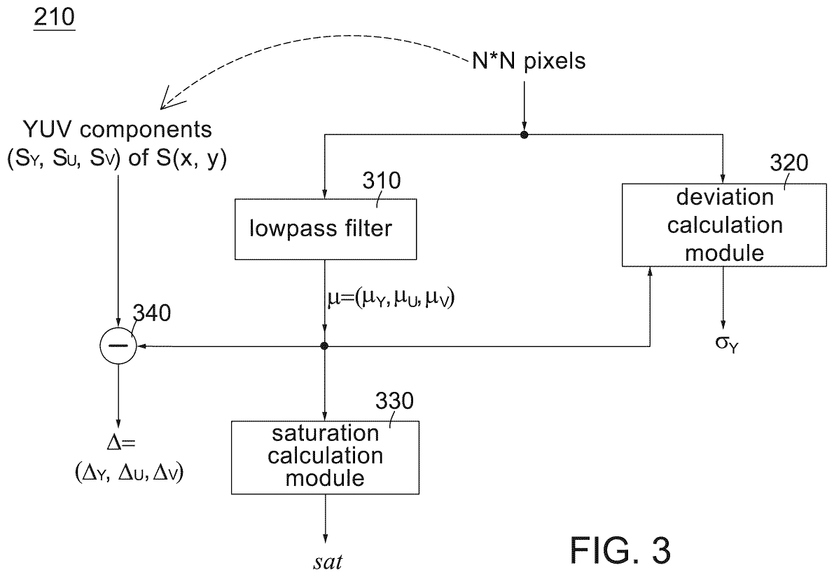

FIG. 3 is a schematic diagram of a LWS module 210 according to an embodiment of the invention. Referring to FIG. 3, the LWS module 210 includes a lowpass filter 310, a deviation calculation module 320, a saturation calculation module 330 and a subtractor 340. The lowpass filter 310 (corresponding to the 3×3 single local window) performs lowpass filtering over YUV components of the group of nine pixels to generate a filtered pixel value μ with YUV components (μ_{Y}, μ_{U}, μ_{V}) for the center pixel S(x, y). In an embodiment, the filtered pixel value μ is obtained by calculating the mean value μ of the group of nine pixels, i.e.,

$$μ = ( {μ}_{Y} , {μ}_{U} , {μ}_{V} ) = ( ( {\sum }_{i = 1}^{n} {Y}_{i} ) / n , ( {\sum }_{i = 1}^{n} {U}_{i} ) / n , ( {\sum }_{i = 1}^{n} {V}_{i} ) / n ) ,$$

where Yi, Ui and Vi respectively represent Y, U and V components of a pixel i among the group of nine pixels for n=N². As well known in the art, a standard deviation is a measure of the amount of variation of multiple values about its mean value. In an embodiment, the following program codes are provided to calculate a standard deviation oy for Y components of the group of nine pixels in the deviation calculation module 320:

$$T = ( ( {\sum }_{i = 1}^{n} {Y}_{i}^{2} ) / n ) - {μ}_{Y}^{2} ;$$

$${σ}_{Y} = \sqrt{( T < 0 ? 0 : T )} ; // if T < 0 , then {σ}_{Y} = 0 , otherwise {σ}_{Y} = \sqrt{T}$$

The saturation calculation module 330 calculates a saturation index sat according to the mean value μ and the following equation: sat=\sqrt{(μ_{U}−128)²+(μ_{V}−128)²}. Finally, the subtractor 340 respectively subtracts YUV components (μ_{Y}, μ_{U}, μ_{V}) of the mean value μ from the YUV components (S_{Y}, S_{U}, S_{V}) of the center pixel S(x, y) to produce a difference value Δ with YUV components (Δ_{T}, Δ_{U}, Δ_{V}), i.e., Δ_{Y}=(S_{Y}−μ_{Y}), Δ_{U}=(S_{U}−μ_{U}) and Δ_{V}=(S_{V}−μ_{V}).

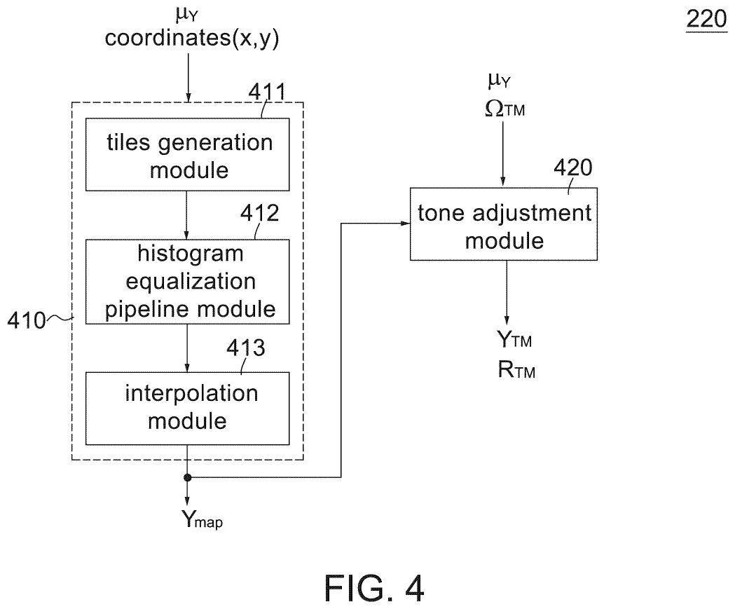

FIG. 4 is a schematic diagram of TM module 220 according to an embodiment of the invention. Referring to FIG. 4, the TM module 220 includes a histogram equalization module 410 and a tone adjustment module 420. It is well known that contrast-limited adaptive histogram equalization (CLAHE) algorithm is used to improve local contrast and enhance edge definition in each region of the current image. In an embodiment, the histogram equalization module 410 operates based on CLAHE and includes a tiles generation module 411, a histogram equalization pipeline module 412, and an interpolation module 413. Please note that the tiles generation module 411 and the histogram equalization pipeline module 412 operate based on a previous image, and the bilinear interpolation module 413 operates based on the current image. The tiles generation module 411 divides all the mean values μ_{Y} corresponding to all the pixels of the previous image into multiple equal-size tiles, such as 64×64 or 256×256. The histogram equalization pipeline module 412 firstly performs histogram equalization on each tile from the tiles generation module 411 using a pre-defined clip limit, and then computes a cumulative distribution function (CDF) and a tone mapping function for each tile of the previous image. According to the coordinates (x,y) of the center pixel, the mean value μ_{Y} from the LWS module 210 and up to four tone mapping functions of up to four tiles closest to the center pixel S(x,y), the histogram equalization pipeline module 412 generates up to four mapped values. Finally, the interpolation module 413 obtains an interpolated value Yₘₐₚ for the center pixel S(x,y) by performing bilinear or linear interpolation computations over the up to four mapped values. Please note that CLAHE used in the histogram equalization module 410 is provided by way of example and not limitation of the invention. In actual implementations, any other histogram equalization may be used and this also falls in the scope of the invention.

In an embodiment, the following program codes are provided to calculate a blended value Y_{TM} and a luma rate R_{TM} for the center pixel S(x,y) according to the mapped luma value Yₘₐₚ, the mean value μ_{Y} and a user-defined blending parameter Ω_{TM} in the tone adjustment module 420:

$${Y}_{TM} = ( 1 - {Ω}_{TM} ) \times {μ}_{Y} + {Ω}_{TM} \times {Y}_{map} ; // the parameter {Ω}_{TM} ranges from 0 to 1$$

$${R}_{TM} = {μ}_{Y} > 0 ? ( {Y}_{TM} / {μ}_{Y} ) : 1 ; // if {μ}_{Y} > 0 , {R}_{TM} = ( {Y}_{TM} / {μ}_{Y} ) , otherwise , {R}_{TM} = 1$$

It is well known that tone mapping is used to enhance contrast. However, noise is subject to be amplified if the initial Y component (S_{Y}) of the center pixel S(x,y) is used as an input for the TM module 220 to perform tone mapping. Instead, the mean value (i.e., the output of the lowpass filter 310) μ_{Y} is used as the input for the TM module 220 to perform tone mapping in this invention in order to reduce noise.

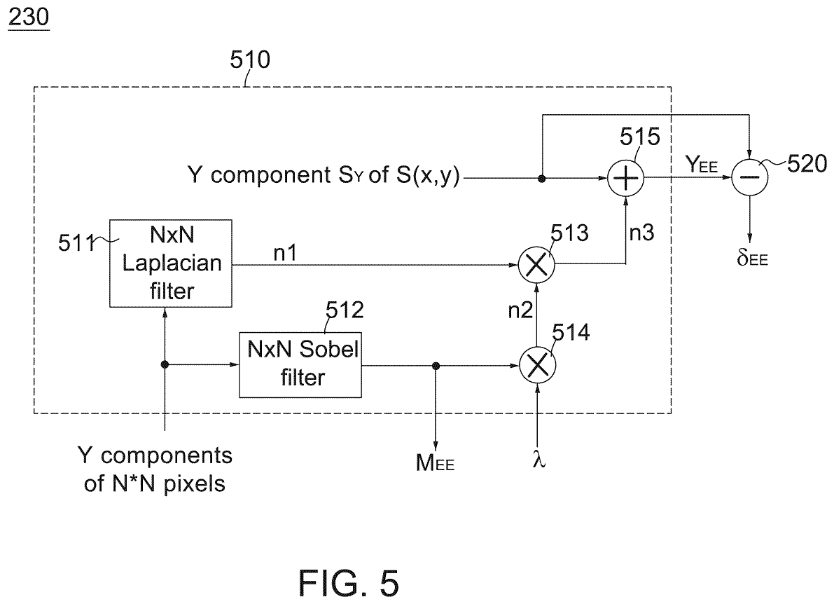

FIG. 5 is a schematic diagram of EE module 230 according to an embodiment of the invention. Referring to FIG. 5, the EE module 230 includes an EE filter 510 and a subtractor 520. The EE module 230 is configured to improve sharpness by edge detection. The EE filter 510 may be implemented by any known edge enhancement filter that performs edge enhancement filtering over Y components of the group of nine pixels to generate a gradient magnitude MEE and an edge-enhanced luma value YEE. The diagram of the EE filter 510 in FIG. 5 is provided by way of example and not limitation of the invention. The EE filter 510 includes a N×N Laplacian filter 511, a N×N Sobel filter 512, two multipliers 513˜514 and an adder 515. As well known in the art, the first derivative of an image measures the rate of change of pixel intensity. It is useful for detecting edges because edges are locations in the image where the intensity changes rapidly. A Sobel filter is a gradient based edge detector that uses a horizontal kernel and a vertical kernel separately to compute gradient magnitude representations along the x and y axis, allowing us to find both horizontal and vertical edge-like regions. The second derivative of an image measures the rate of change of the first derivative. It is useful for detecting edges because zero-crossings (points where the second derivative changes sign) often correspond to edges. A Laplacian filter is an edge detector that uses only one symmetric kernel to compute the second derivatives in a single pass.

Due to N=3, the 3×3 Laplacian filter 511 (corresponding to the 3×3 single local window) uses a 3×3 Laplacian kernel to convolve with Y components of the group of nine pixels to calculate the second derivative value n1 while the N×N Sobel filter 512 (corresponding to the 3×3 single local window) separately applies a 3×3 horizontal kernel and a 3×3 vertical kernel to convolve with Y components of the group of nine pixels to obtain a horizontal gradient Gx and a vertical gradient Gy. Next, the N×N Sobel filter 512 computes the gradient magnitude MEE according to the horizontal gradient Gx and the vertical gradient Gy by using the equation:

$${M}_{EE} = \sqrt{{G}_{x}^{2} + {G}_{y}^{2}} .$$

The multiplier 514 multiplies the gradient magnitude M_{EE} by an input parameter λ to produce a product n2. The multiplier 513 multiplies the second derivative value n1 by the product n2 to produce a product n3. The adder 515 adds the original Y component S_{Y} of the center pixel S(x,y) and n3 to generate an edge-enhanced luma value Y_{EE} for the center pixel S(x,y). Then, the subtractor 520 subtracts the value Y_{EE} from the original Y component S_{Y} to generate a difference δ_{EE} for the center pixel S(x,y). Please note that only Y components of the group of the nine pixels are analyzed in the TM module 220 and the EE module 230.

The AP module 240 receives multiple parameters (σ_{Y}, sat, Δ, μ, Y_{TM}, R_{TM}, M_{EE}, δ_{EE}) from its upstream module 210˜230 and multiple user-defined parameters (Ω_{LWS}, Ω_{EE}, Ω_{C}, Ω_{TM}) to perform a computation pipeline. The computation pipeline is divided into three stages: first stage (or β stage), second stage (or α stage) and final stage (or blending stage). In the first stage (or β stage), the following program codes are provided to calculate all B factors according to three thresholds (THₛₐₜ, TH_{dev}, TH_{EE}), the saturation index sat, the gradient magnitude M_{EE} and the standard deviation or in the AP module 240:

$${β}_{dev} = {σ}_{Y} > {TH}_{{dev}^{}} ? 1 : ( {σ}_{Y} / {TH}_{d e v} ) ; // {β}_{dev} is a deviation factor and {TH}_{dev} is a deviation threshold$$

$${β}_{EE} = {M}_{EE} > {TH}_{{EE}^{}} ? 1 : ( {M}_{EE} / {TH}_{EE} ) ; // {β}_{EE} is an EE factor and {TH}_{EE} is an EE threshold$$

$${β}_{LWS} = 1 - ( {β}_{dev} + {β}_{EE} ) / 2 ; // {β}_{LWS} is a LWS factor$$

$${β}_{sat} = sat > {TH}_{sat} ? 1 : sat / {H}_{sat} ; // {β}_{sat} is a saturation factor and {TH}_{sat} is a saturation threshold ; if sat > {TH}_{sat} , {β}_{sat} = 1 , otherwise , {β}_{sat} = sat / {TH}_{sat}$$

In an alternative embodiment, the factor βₛₐₜ is calculated as:

$${β}_{sat} = sat > 100 ? 0 : sat > {TH}_{sat} ? ( 100 - sat ) / ( 100 - {TH}_{sat} ) : sat / {TH}_{sat} ; // if sat > 100 , {β}_{sat} = 0 , otherwise , check whether sat > {TH}_{sat} , if YES , then {β}_{sat} = ( 100 - sat ) / ( 100 - {TH}_{sat} ) , otherwise , {β}_{sat} = sat / {TH}_{sat} .$$

In the second stage (or α stage), the following program codes are provided to calculate all weights α according to the B factors, the mean value μ_{Y} and four user-defined parameters (Ω_{LWS}, Ω_{EE}, Ω_{TM}, Ω_{C}) in the AP module 240:

$${α}_{LWS} = 1 - {Ω}_{LWS} \times {β}_{LWS} ; // {α}_{LWS} is a LWS weight$$

$${α}_{EE} = {Ω}_{EE} \times {β}_{dev} ; // {α}_{EE} is an EE weight gain = ( {μ}_{Y} == 0 ‖ {μ}_{Y} == 255 ) ? 1 : {R}_{TM} ;$$

$${α}_{TM} = ( 1 - {Ω}_{TM} ) + {Ω}_{TM} \times gain ; // {α}_{TM} is a chroma rate$$

$${α}_{C} = {α}_{TM} \times {β}_{sat} \times {Ω}_{C} ; // {α}_{C} is a chroma weight$$

In an alternative embodiment, the weight ac is calculated as a_{C}=(1+(A_{TM}−1)×bₛₐₜ)×W_{C}; the parameter gain is calculated as:

$$gain = ( {m}_{Y} == 0 ‖ {m}_{Y} == 255 ) ? 1 : {m}_{Y} < 128 ? ( 255 - {Y}_{TM} ) / ( 255 - {m}_{Y} ) ; // if ( {m}_{Y} == 0 ‖ {m}_{Y} == 255 ) , gain = 1 , otherwise , check whether {m}_{Y} < 128 , if YES , gain = {R}_{TM} , otherwise , gain = ( 255 - {Y}_{T M} ) / ( 255 - {m}_{Y} ) .$$

Here, Ω_{TM} is a user-defined TM strength and ranges from 0 to 1, Ω_{LWS} is a user-defined LWS strength and ranges from 0 to 1, δ_{EE} is a user-defined EE strength and ranges from 0 to ∞, and Ω_{C} is a user-defined chroma strength and ranges from 0 to ∞. On the other hand, α_{LWS} can be regarded as a function of “σ_{Y}, M_{EE}, and Ω_{LWS}”, i.e., α_{LWS}=f(σ_{Y}, M_{EE}, Ω_{LWS}); α_{EE} can be regarded as a function of “σ_{Y} and δ_{EE}”, i.e., α_{EE}=f(σ_{Y}, δ_{EE}); and, α_{C} can be regarded as a function of “sat, R_{TM}, Ω_{C} and Ω_{TM}”, i.e., α_{C}=f(sat, R_{TM}, Ω_{C}, Ω_{TM}).

In the final stage (or blending stage), the following program codes are provided to calculate enhanced components Y′U′V′ of the center pixel S(x,y) according to the parameters (Δ, μ, Y_{TM}, δ_{EE}) and all the weights α in the AP module 240:

$${Y}^{′} = {Y}_{TM} + {α}_{LWS} \times {Δ}_{Y} + {α}_{EE} \times {δ}_{EE} ; \qquad // Equation 1$$

$${U}^{′} = 128 + {α}_{C} \times ( {μ}_{U} - 128 ) + {α}_{LWS} \times {Δ}_{U} ;$$

$${V}^{′} = 128 + {α}_{C} \times ( {μ}_{V} - 128 ) + {α}_{LWS} \times {Δ}_{V} ;$$

As shown above, the enhanced component Y′ includes a TM portion (Y_{TM}), a noise reduction portion (α_{LWS}×Δ_{Y}) and an edge enhancement portion (α_{EE}×δ_{EE}). The enhanced component U′ includes a chroma portion (α_{C}×(μ_{U}−128)) and a noise reduction portion (α_{LWS}×Δ_{U}). The enhanced components V′ includes a chroma portion (α_{C}×(μ_{V}−128)) and a noise reduction portion (α_{LWS}×Δ_{V}). The image enhancement apparatus 200 is configured to simultaneously process the current image with three different image enhancement techniques, i.e., noise reduction, edge enhancement, and local contrast enhancement. Specifically, detailed information (such as deviations and edge detection) about the current image is analyzed to adjust multiple weights (such as α_{LWS}, α_{EE} and α_{C}) for image smoothing and edge enhancement. For example, referring to Equation 1, to smooth the current image, α_{LWS} is expected to approach zero to achieve the goal of removing Δ_{Y}; contrarily, if α_{LWS} approaches 1, the original Y component (S_{Y}) would be restored and thus no image smoothing effect is produced. On the other hand, α_{EE} can be regarded as a gain control with edge enhancement; when α_{EE} approaches 0, no edge enhancement effect is produced. Chroma values (U′N′ components) need to be adjusted for the center pixel S(x,y) after the luma value (Y′ component) is updated, otherwise it may cause insufficient color saturation. Accordingly, ac is used to compensate for the insufficient color saturation.

Finally, the center pixel S(x,y) with the enhanced components Y′U′V′ is stored in the output buffer 260 according to its coordinates (x,y). In the same manner, all the pixels in the current image are then processed to obtain the enhanced image in the output buffer 260.

The LWS module 210, the TM module 220, the EE module 230, and the AP module 240 according to the invention may be implemented by hardware, software, or a combination of hardware and software (or firmware). An example of a pure solution would be a FPGA design or an ASIC design. In an embodiment, the LWS module 210, the TM module 220, the EE module 230, and the AP module 240 are implemented with a general-purpose processor and a program memory. The program memory stores a processor-executable program. When the processor-executable program is executed by the general-purpose processor, the general-purpose processor is configured to function as: the LWS module 210, the TM module 220, the EE module 230, and the AP module 240.

The functionality of The LWS module 210, the TM module 220, the EE module 230, and the AP module 240 and their respective components, as well as the methods step and blocks may be implemented by software, hardware, firmware, or a combination thereof. The software/firmware may be a program having sets of instructions executable by one or more digital circuits, such as CPUs, microprocessors, digital signal processors (DSPs), embedded controllers, or intellectual property (IP) cores. If implemented in software/firmware, the functions may be stored as instructions or code on one or more computer-readable media. Computer-readable medium includes computer storage medium, including any non-transitory medium that facilitates transfer of a computer program from one place to another. A storage medium may be any available medium that can be accessed by a computer. By way of example, and not limitation, such computer-readable medium can comprise RAM, ROM, EEPROM, CD-ROM and DVD-ROM disks, flash memory devices, magnetic disk storage devices, or any other medium that can be used to store desired program codes in the form of instructions or data structures and that can be accessed by a computer. Combinations of the above should also be included within the scope of computer-readable medium.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. An image enhancement apparatus, comprising:
N line buffers for receiving pixels of N rows in an image and outputting N² pixels according to a N×N local window sliding across the image;
local window statistics (LWS) circuitry configured to perform lowpass filtering operation over values of the N² pixels to generate a filtered value μ, and to calculate a difference value Δ between the filtered value μ and a value of a center pixel of the N² pixels located at a center of the N×N local window;
tone mapping (TM) circuitry configured to produce a mapped value Yₘₐₚ according to a luma component μ_{Y} of the filtered value μ and coordinates of the center pixel;
edge enhancement (EE) circuitry configured to perform edge-enhancement filtering over the luma components of the N² pixels to produce a luma difference δ_{EE}; and
adaptive processing (AP) circuitry configured to update the luma component of the center pixel according to four outputs (μ_{Y}, Δ_{Y}, Yₘₐₚ, δ_{EE}) from the LWS, the TM and the EE circuitry that operate in parallel, where Δ_{Y} denotes a luma component of the difference value Δ.

2. The apparatus according to claim 1, wherein the AP circuitry is further configured to update the chroma components of the center pixel according to chroma components of both the filtered value μ and the difference value Δ.

3. The apparatus according to claim 2, wherein the AP circuitry is further configured to update the luma and the chroma components of the center pixel by the following equations:
$${Y}^{′} = {Y}_{TM} + {α}_{LWS} \times {Δ}_{Y} + {α}_{EE} \times {δ}_{EE} ;$$
$${U}^{′} = 128 + {α}_{C} \times ( {μ}_{U} - 128 ) + {α}_{LWS} \times {Δ}_{U} ;$$
$${V}^{′} = 128 + {α}_{C} \times ( {μ}_{V} - 128 ) + {α}_{LWS} \times {Δ}_{V} ;$$
wherein Δ_{U} and Δ_{V} respectively denote U and V components of the difference value Δ, and μ_{U} and μ_{V} respectively denote U and V components of the filtered value μ;
wherein α_{LWS} is related to a degree of image smoothing, α_{EE} is related to a degree of edge enhancement and α_{C} is for color saturation compensation; and
wherein Y_{TM} is a combination of Yₘₐₚ and μ_{Y}.

4. The apparatus according to claim 3, wherein the LWS circuitry is further configured to calculate a saturation index (sat) according to the chroma component of the filtered value μ and calculate a standard deviation σ_{Y} according to the luma components of the N² pixels, wherein the TM circuitry is further configured to compute a ratio R_{TM} Of Yₘₐₚ to μ_{Y}, and wherein the EE circuitry is further configured to perform the edge-enhancement filtering over the luma components of the N² pixels to produce a gradient magnitude M_{EE}.

5. The apparatus according to claim 4, wherein the EE circuitry comprises:
a N×N Sobel filter for performing edge detection over the luma components of the N² pixels to generate a horizontal gradient and a vertical gradient that are related to M_{EE}.

6. The apparatus according to claim 4, wherein α_{LWS} is a function of σ_{Y}, M_{EE} and Ω_{LWS}, and wherein Ω_{LWS} ranges from 0 to 1.

7. The apparatus according to claim 4, wherein α_{EE} is a function of σ_{Y} and Ω_{EE}, and Ω_{EE} ranges from 0 to ∞.

8. The apparatus according to claim 4, wherein α_{C} is a function of sat, μ_{Y}, R_{TM}, Ω_{C} and Ω_{TM}, and wherein Ω_{C} ranges from 0 to ∞, and Ω_{TM} ranges from 0 to 1.

9. An image enhancement method, comprising:
storing pixels of N rows in an image by N line buffers to output N² pixels according to a N×N local window sliding across the image;
at a local window statistics (LWS) module,
performing lowpass filtering operation over values of the N² pixels to generate a filtered value μ, and calculating a difference value Δ between μ and a value of a center pixel of the N² pixels located at a center of the N×N local window;
at a tone mapping (TM) module,
producing a mapped value Yₘₐₚ according to a luma component μ_{Y} of the filtered value μ and coordinates of the center pixel;
at an edge enhancement (EE) module,
performing edge-enhancement filtering over the luma components of the N² pixels to produce a luma difference δ_{EE}; and
at an adaptive processing (AP) module, updating the luma component of the center pixel according to four outputs (μ_{Y}, Δ_{Y}, Yₘₐₚ, δ_{EE}) from the LWS, the TM and the EE modules that operate in parallel, where Δ_{Y} denotes a luma component of Δ.

10. The method according to claim 9, wherein the step of updating the luma component further comprises:
updating the luma component of the center pixel by the following equations:
$${Y}^{′} = {Y}_{TM} + {α}_{LWS} \times {Δ}_{Y} + {α}_{EE} \times {δ}_{EE} ;$$
wherein α_{LWS} is related to a degree of image smoothing and α_{EE} is related to a degree of edge enhancement; and
wherein Y_{TM} is a combination of Yₘₐₚ and μ_{Y}.

11. The method according to claim 10, further comprising:
at the LWS module,
calculating a standard deviation σ_{Y} according to the luma components of the N² pixels; and
at the EE module,
performing the edge-enhancement filtering over the luma components of the N² pixels to produce a gradient magnitude M_{EE}.

12. The method according to claim 11, wherein the step of performing the edge-enhancement filtering further comprises:
applying a N×N Sobel filter to the luma components of the N² pixels to produce a horizontal gradient and a vertical gradient that are related to the gradient magnitude M_{EE}.

13. The method according to claim 11, wherein α_{LWS} is a function of σ_{Y}, M_{EE} and Ω_{LWS}, and wherein Ω_{LWS} ranges from 0 to 1.

14. The method according to claim 11, wherein α_{EE} is a function of σ_{Y} and Ω_{EE}, and Ω_{EE} ranges from 0 to ∞.

15. The method according to claim 9, further comprising:
at the AP module, updating chroma components of the center pixel according to chroma components of both the filtered value μ and the difference value Δ.

16. The method according to claim 15, wherein the step of updating the chroma components further comprises:
updating the chroma components of the center pixel by the following equations:
$${U}^{′} = 128 + {α}_{C} \times ( {μ}_{U} - 128 ) + {α}_{LWS} \times {Δ}_{U} ;$$
$${V}^{′} = 128 + {α}_{C} \times ( {μ}_{V} - 128 ) + {α}_{LWS} \times {Δ}_{V} ;$$
wherein Δ_{U} and Δ_{V} respectively denote U and V components of the difference value Δ, and μ_{U} and μ_{V} respectively denote U and V components of the filtered value μ; and
wherein α_{LWS} is related to a degree of image smoothing and α_{C} is for color saturation compensation.

17. The method according to claim 16, further comprising:
at the LWS module,
calculating a saturation index (sat) according to the chroma component of μ; and
calculating a standard deviation σ_{Y} according to luma components of the N² pixels;
at the TM module,
computing a ratio R_{TM} of Yₘₐₚ to μ_{Y}; and
at the EE module,
performing the edge-enhancement filtering over the luma components of the N² pixels to produce a gradient magnitude M_{EE}.

18. The method according to claim 17, wherein the step of performing the edge-enhancement filtering further comprises:
applying a N×N Sobel filter to the luma components of the N² pixels to produce a horizontal gradient and a vertical gradient that are related to the gradient magnitude M_{EE}.

19. The method according to claim 17, wherein α_{LWS} is a function of σ_{Y}, M_{EE} and Ω_{LWS}, and wherein Ω_{LWS} ranges from 0 to 1.

20. The method according to claim 17, wherein α_{C} is a function of sat, μ_{Y}, R_{TM}, Ω_{C} and Ω_{TM}, and wherein Ω_{C} ranges from 0 to ∞, and Ω_{TM} ranges from 0 to 1.
